(19) United States
(12) Patent Application Publication
(10) Pub. No.: US 2009/0183621 A1
(43) Pub. Date: Jul. 23, 2009

(54) SUPPORT FOR STRINGED MUSICAL INSTRUMENTS

(76) Inventor: Luca Cianfriglia, Torino (IT)

Correspondence Address: HESLIN ROTHENBERG FARLEY & MESITI PC, 5 COLUMBIA CIRCLE, ALBANY, NY, 12203, US

(21) Appl. No.: 12/301,154

(22) PCT Filed: May 15, 2007
(86) PCT No.: PCT/IB07/01395

§ 371 Date: Nov. 17, 2008

(30) Foreign Application Priority Data
May 17, 2006 (IT) TO2006U000071

(51) Int. Cl. G10G 5/00

(52) U.S. Cl. 84/327

(57) ABSTRACT

A support for stringed musical instruments includes a resting base and a supporting upright for supporting the instrument, the support being formed by elements that are mobile between a condition of use and a folded or collapsed condition for being carried. The mobile elements are shaped like a plane plate to enable the support, in its collapsed condition, to be housed and carried inside the case of the musical instrument, even in contact with the latter, and define respective extensive surfaces that can be used for application of advertising and promotional information, and the like.

### FIELD OF THE INVENTION

The present invention relates in general to stringed musical instruments (guitar, bass, violin, violoncello, double-bass, etc.), and regards more in particular a support for musical instruments of this sort.

### STATE OF THE PRIOR ART

Supports for stringed musical instruments consist traditionally in tubular or bar-like structures that constitute a rigid, cumbersome and, in the majority of cases, relatively heavy frame: the most common are frequently even heavier than the instrument itself. Currently no product is known that is able to perform the structural function in terms of strength and safety in supporting the instrument and that at the same time is light, compact and of dimensions and materials such that the support can be housed and carried, together with the instrument, in the corresponding case.

On the other hand, a guitar or a similar stringed musical instrument, owing to its geometrical characteristics, and characteristics of weight and of location of its centroids, does not require particularly large supporting structures: the rigid plastic or metal materials in the form of bars or tubes currently used are oversized with respect to the task that they are expected to perform.

The possibility of inserting the support inside the case for containing the instrument, possibly also in contact therewith without any risk of damaging it, constitutes a need that has been felt for some time by all musicians who have to move with the instrument for their own activity (music lessons, bands, musical groups, concerts, etc.). With traditional supports, the musicians can in general support their own instruments in two different ways: resting them either on the floor or against a wall, with the consequent risk of damage, or else prearranging a series of supports for each place they usually frequent, with consequent additional inconvenience and difficulty of management. The only alternative consists in carrying the support separately from the instrument, which is evidently inconvenient and far from practical.

From the patent documents Nos. US-A-2005/121567 and DE-A-4437200 supports for stringed musical instruments are known having a relatively simplified structure and to some extent lighter than conventional supports formed by tubular or bar-like structures. In both cases, the support has articulated elements that enable, starting from the condition of use, folding thereof in a condition of reduced encumbrance. In particular, the support described in the document No. DE-A-4437200 comprises a resting base and an upright for supporting the instrument, formed by elements that are mobile between a condition of use and a folded or collapsed condition for being carried. Said mobile elements are constituted by separate pieces, in part connected with hinges and in part dismantlable, so that the structure of the support is relatively complex. Furthermore, said mobile elements have a large thickness, due also to the presence of folded perimetral stiffening edges, which render it practically impossible, even in the collapsed condition, to put the support away in the case for the musical instrument and to carry it.

### SUMMARY OF THE INVENTION

The purpose of the present invention is to overcome the aforesaid drawbacks and to provide a support for stringed musical instruments of the type defined in the preamble of claim 1, provided with a simple, light, but nevertheless sturdy structure, and above all with extremely small overall dimensions in the folded or collapsed condition, so as to enable practical housing and carrying thereof directly inside the case of the instrument itself even in contact therewith, without any risk of the instrument possibly getting damaged.

A further purpose of the invention is to provide a support of the type defined above that will render available extensive surfaces suitable for receiving advertising and promotional information or personalized wordings or other features both by the producer of the musical instrument or the retailer and by the user.

A further purpose of the invention is to provide a support for stringed musical instruments of the type defined above which can be produced at relatively modest costs, also with readily recyclable materials so as to enable its acceptance by the market also as promotional object designed to be distributed free of charge by the producers of the instruments or their dealers.

According to the invention, the above purposes are achieved by a support for stringed musical instruments of the type defined at the start of the present description, the main characteristic of which lies in the fact that its elements are shaped as a plane plate.

Said plane-plate elements can be conveniently made of cardboard, and in this case the support may advantageously be formed of a single piece starting from a single dinked and creased plate.

Alternatively, the plane-plate elements can be made of a thermoplastic material, such as, for example, PVC, slightly expanded closed-cell foamed PVC (Forex®), polycarbonate, Plexiglas and even wood or metal.

In any case, the support according to the invention, can be produced in a simple and economically advantageous way, in the condition of use is able to ensure the necessary structural strength, and in its folded or collapsed condition its thickness is reduced to such an extent as to enable housing and carrying thereof inside the case of the musical instrument, without any risk of damage thereto. The plane-plate conformation moreover makes available extensive surfaces designed to receive wordings, images, personalized features and advertising and promotional information.

### BRIEF DESCRIPTION OF THE DRAWINGS

Further characteristics and advantages of the invention will emerge clearly from the ensuing detailed description, with reference to the annexed plates of drawings, which are provided purely by way of non-limiting example and in which:

FIG. 0 is an overall perspective view indicating the basic components of the support for stringed musical instruments according to the invention;

FIG. 1 exemplifies, in two perspective views, the condition of use of the support;

FIG. 2 illustrates, in two further detailed perspective views, the support according to the invention;

FIG. 3 is a perspective view from beneath of the support according to the invention;

FIG. 4 is a rear perspective view of the support according to the invention;

FIG. 5 shows, in three views, the steps of unfolding of the support according to the invention from the condition where it is folded for being carried to that of use, and vice versa;

FIG. 6 is a side elevation showing the support in the folded condition for being carried;

FIG. 7 shows, in five successive steps, designated from 1 to 5, the modalities of construction of the support according to the invention, starting from a single plate made of dinked and creased cardboard;

FIG. 8 shows, in two perspective views, a variant of the support according to the invention; and

FIG. 9 is a side elevation that shows the support of FIG. 8 in the folded condition for being carried.

### DETAILED DESCRIPTION OF THE INVENTION

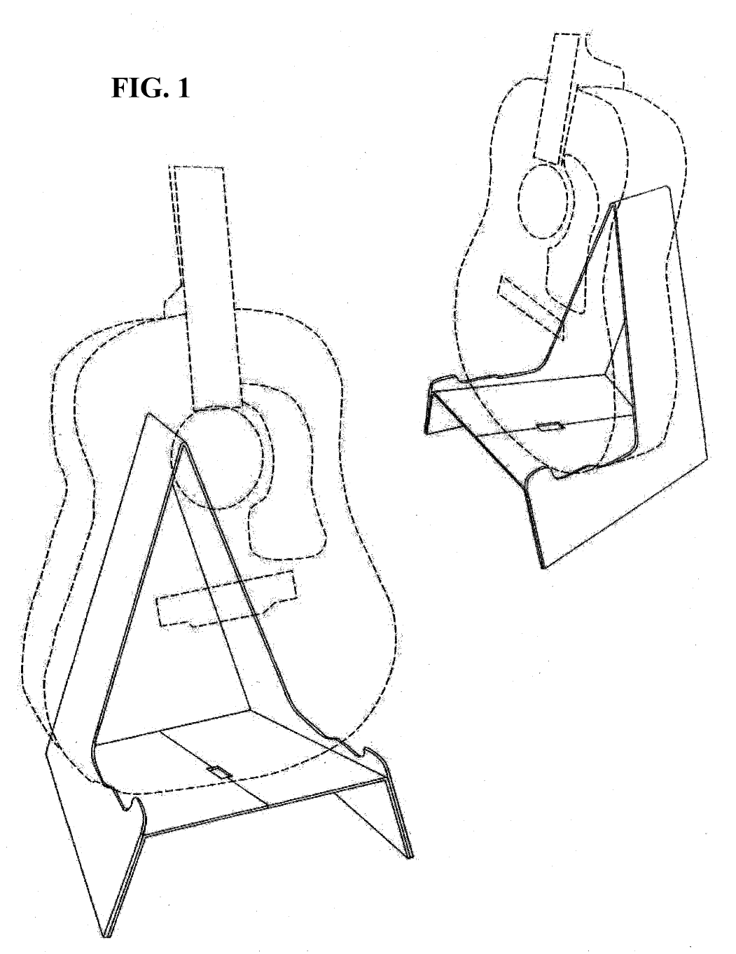

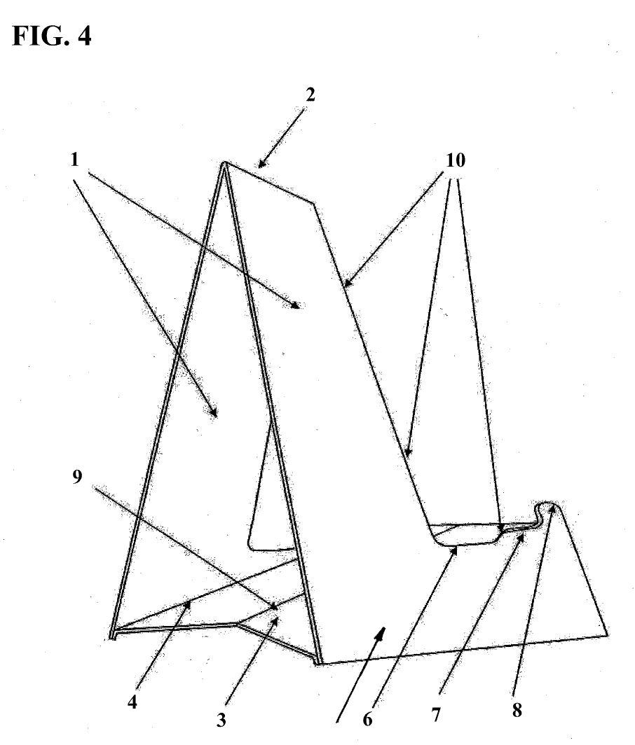

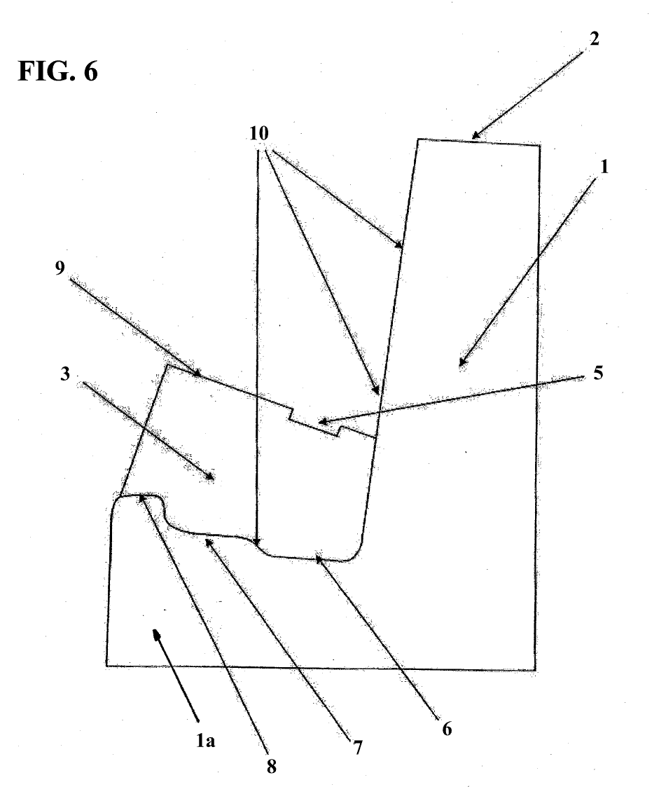

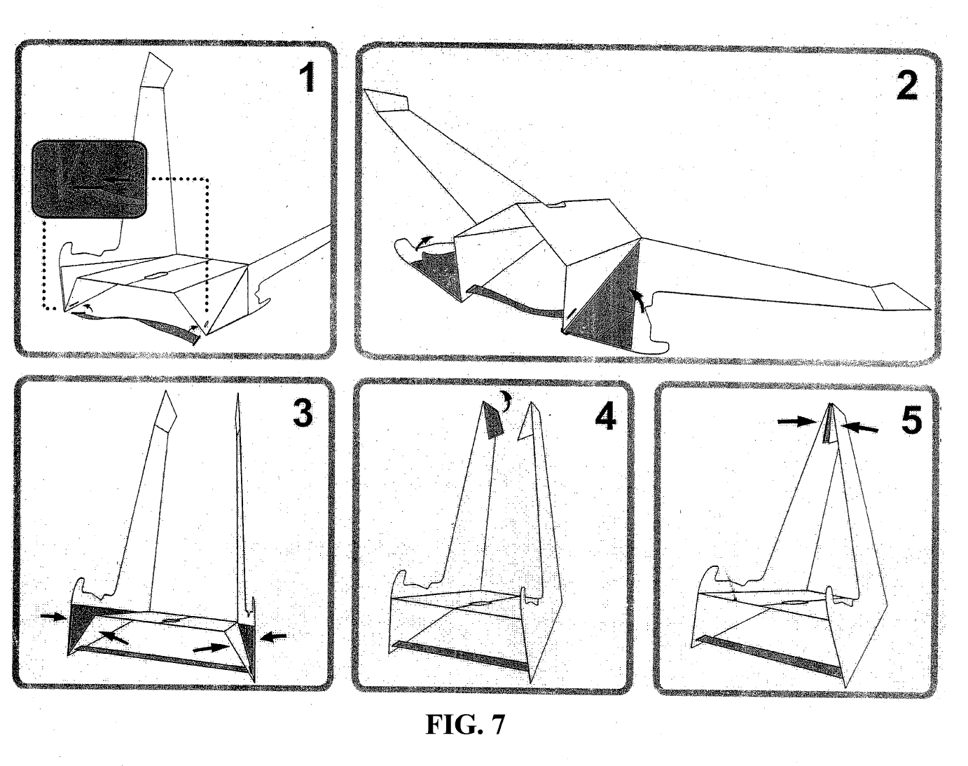

With initial reference to FIG. 0, in a first embodiment the support for stringed musical instruments according to the invention is constituted, in a single piece, basically by a vertical structure X and by a horizontal structure Y. Conveniently, the two structures X and Y form part of a single plate of cardboard or other thin platelike material, such as, for example, a plastic material (PVC, slightly expanded closed-cell foamed PVC, polycarbonate, Plexiglas), or else wood or even metal, and are interconnected via hinges. In the case of cardboard or plastic material, said hinges are integral: lines of creasing or folding in the first case; thin-film hinges in the second case. Said hinges enable, starting from the condition of use represented in FIGS. 0-3, the support to be closed like a book to set it in a collapsed condition of minimal encumbrance represented in the first diagram of FIG. 5 and in FIG. 6, in which its thickness is reduced in such a way as to enable housing thereof inside one and the same case of the musical instrument, and then to be re-opened into the condition of use, in the way exemplified in the other two diagrams of FIG. 5.

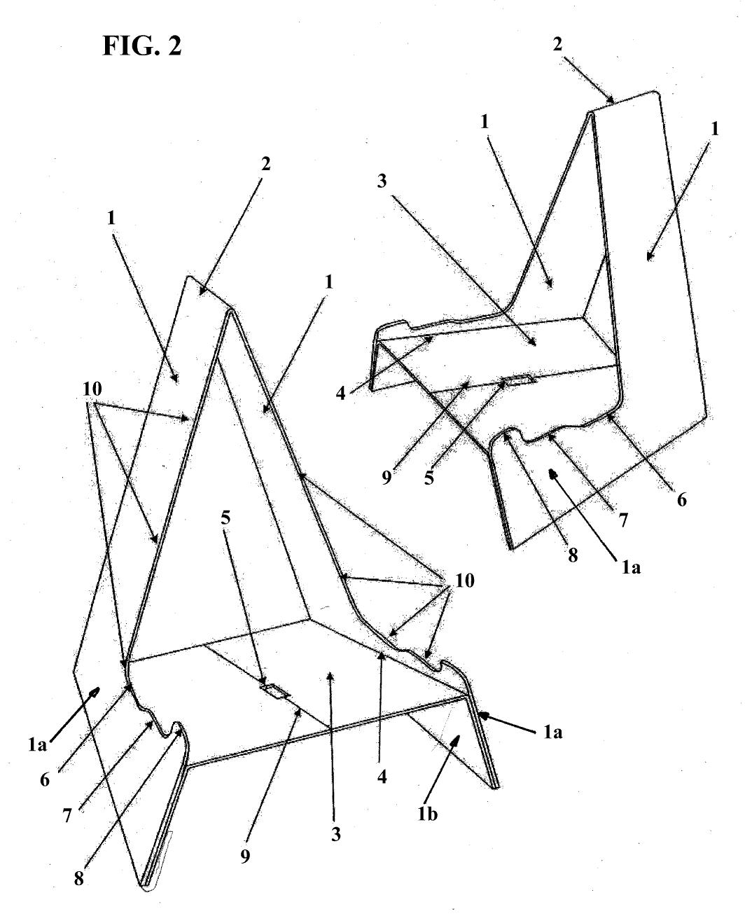

The vertical structure X offers all the rests necessary for the musical instrument, positioned thereon in the way represented in FIG. 1, is in equilibrium: two resting points in the lower part and one resting point in the upper part to prevent the instrument from being knocked over. The horizontal structure Y joins, reinforces, and renders stable and firm the elements that constitute the vertical structure X, and has an elongated opening Z, the function of which is to receive the tail spike (in the case, for example, of the violoncello and of the double-bass) or the pins for anchorage of the shoulder strap (in the case, for example, of the majority of guitars and basses) present in the lower part of the acoustic boxes of musical instruments. When the tail spike or pin penetrates inside the opening Z, the instrument resting on the support, in the way represented in FIG. 1, is positioned stably, thus preventing any risk of it falling accidentally.

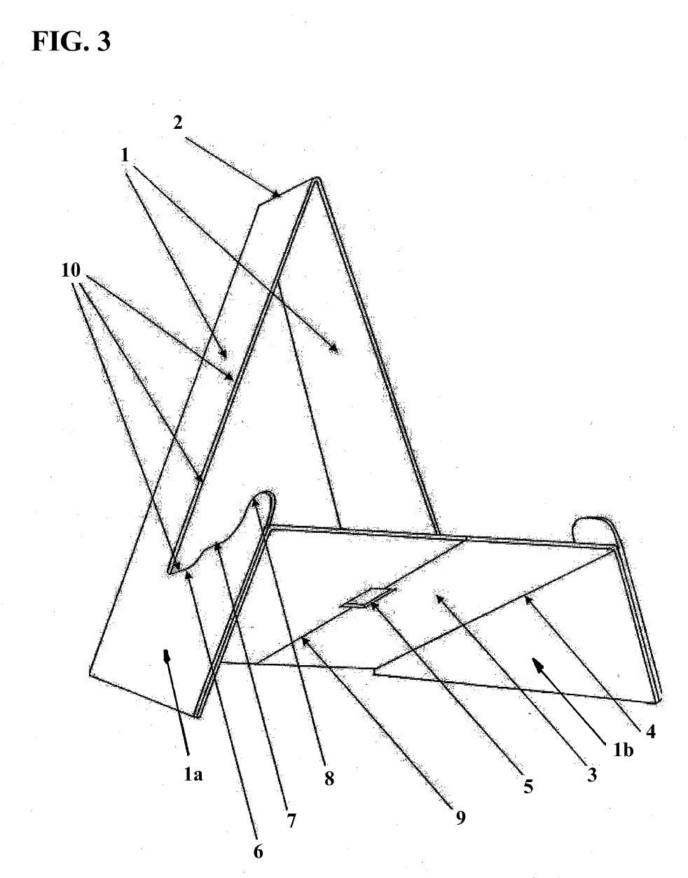

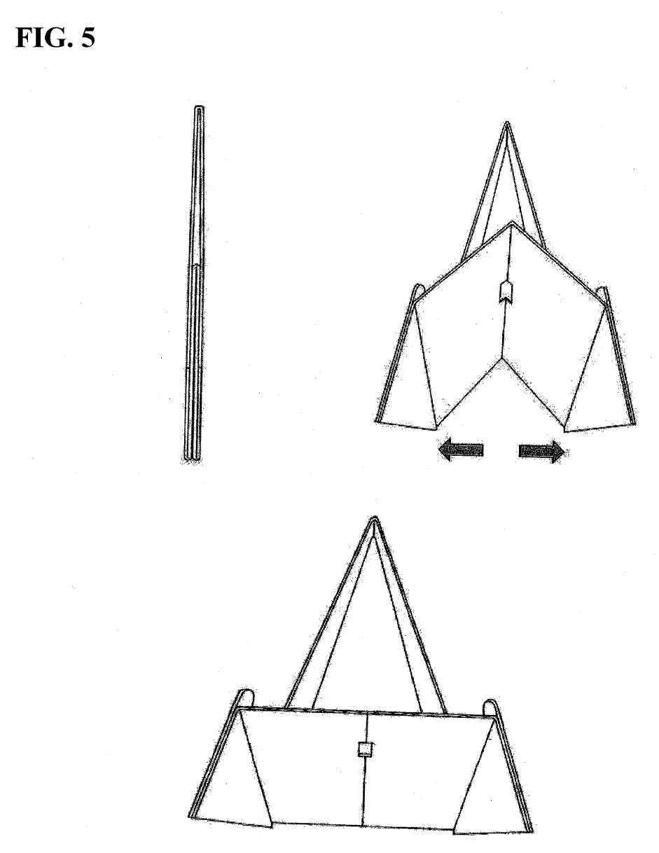

With reference now in greater detail to FIGS. 2 to 5, the support according to the invention, in this case preferably made starting from a single plane plate made of dinked and creased cardboard, comprises two side pieces 1 having respective extensive surfaces that can be used for application of advertising and promotional information, and the like, connected together at the upper end in an area corresponding to a line of folding 2. As will be seen, said line of folding 2 is in effect constituted by a foldable joint, which joins, for example, by means of gluing, the top ends of the two side pieces 1 for closing, when being assembled, the plate that constitutes the support. In this way, the two side pieces 1 are articulated together like a book to be able to rotate between the open position of use, in which they present a substantially triangular arrangement, and the closed position for being carried, in which they are set against one another.

At the bottom, the two side pieces 1 have respective appendages 1a defining two resting feet, which are connected together by a connecting platform 3, in an area corresponding to lines of folding 4, to respective internal flaps 1b, folded and fixed, for example, via gluing, to the internal faces of the feet 1a.

The platform 3 has a central folding line 9, via which it can be folded inside the side pieces 1 and the feet 1a, in the way represented in FIG. 6, when the support is set in the collapsed position for being carried. A through opening 5 having a generally elongated shape (corresponding to the opening Z of FIG. 0) is made approximately in the median area of the line of folding 9 so as to be able to receive, as already explained previously, the tail spike or the pin for anchorage of the shoulder strap present in the lower part of the acoustic box of the stringed instrument designed to be rested on the support.

The top edges of the appendages of the side pieces 1 defining the resting feet 1a have a peculiar shaping, thanks to which the support according to the invention enables a stable positioning of stringed instruments that have acoustic boxes of different thicknesses. In particular, said edges are formed adjacent to the side pieces 1 with first seats 6 designed to receive and support instruments with thinner acoustic boxes (e.g., electric, semi-acoustic, guitars, electric basses, violas, violins, etc.) followed, towards the free ends of the feet 1a, by second seats 7, designed to receive and support instruments with acoustic boxes that are thicker (e.g., classic, acoustic, guitars, violoncellos, double-basses, etc.).

The top edges of the feet 1a moreover have, in the proximity of the respective free ends, stopper projections 8 having the function of preventing the acoustic box of the instrument resting on the support from slipping forwards.

Both the top edges of the feet 1a, along the seats 6 and 7 and the stopper projections 8, and the front edges of the side pieces 1 can be coated with strips (not illustrated in the drawings) of anti-slip material, such as rubber, silicone, neoprene, etc.

FIG. 5 shows the sequence of unfolding of the support according to the invention, starting from the folded condition for being carried (represented at the top left) to the unfolded configuration of use (represented at the bottom), passing through the intermediate configuration illustrated in the representation at the top right, and consequently the reverse sequence of folding. As may be seen, in the folded condition the support has an extremely small thickness and is compact so as to enable housing thereof directly inside the case for carrying the instrument itself, even in contact with the instrument without any risk of damage thereto.

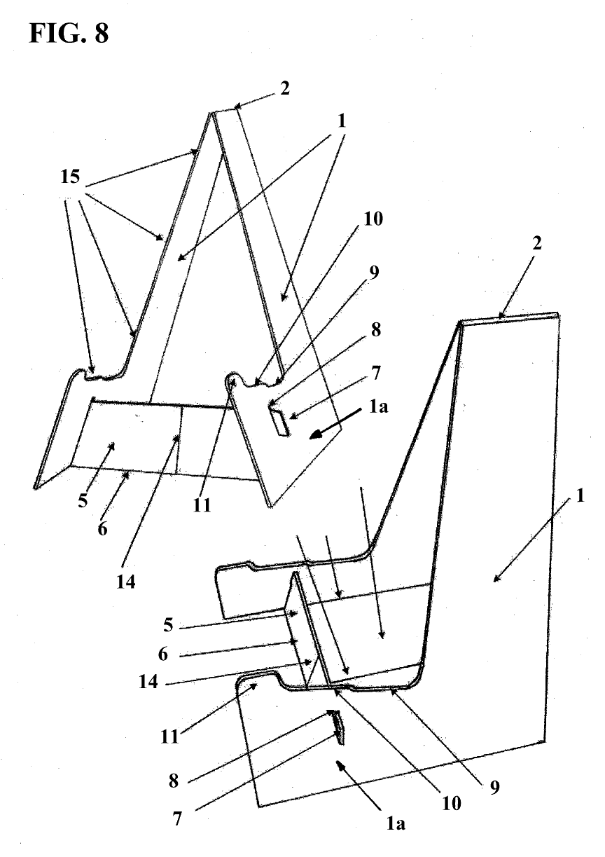

FIG. 7 shows the sequence of assembly of the support according to the invention, starting from the single plate of dinked and creased cardboard (or even from a plate of plastic material with flexible hinges) by means of simple folding operations. As already clarified previously, provided in this case are joining parts for gluing in an area corresponding to the tops 2 of the side pieces 1 and between the appendages 1a thereof and the folded flaps 1b.

In order to guarantee a greater stability of the support, the feet 1a can possibly be interconnected by a flexible stay, in the way illustrated in FIG. 7.

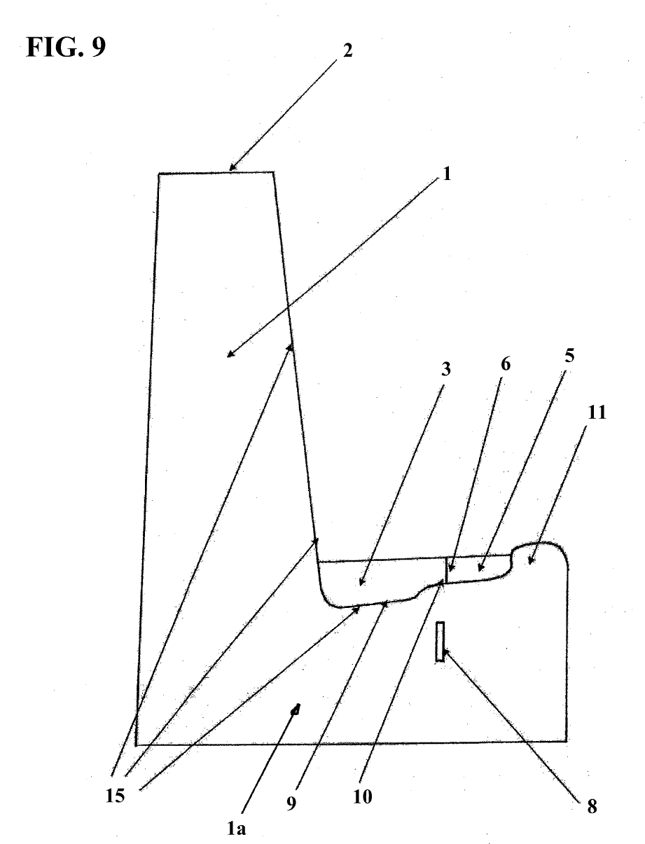

FIG. 8 shows a variant of the support according to the invention.

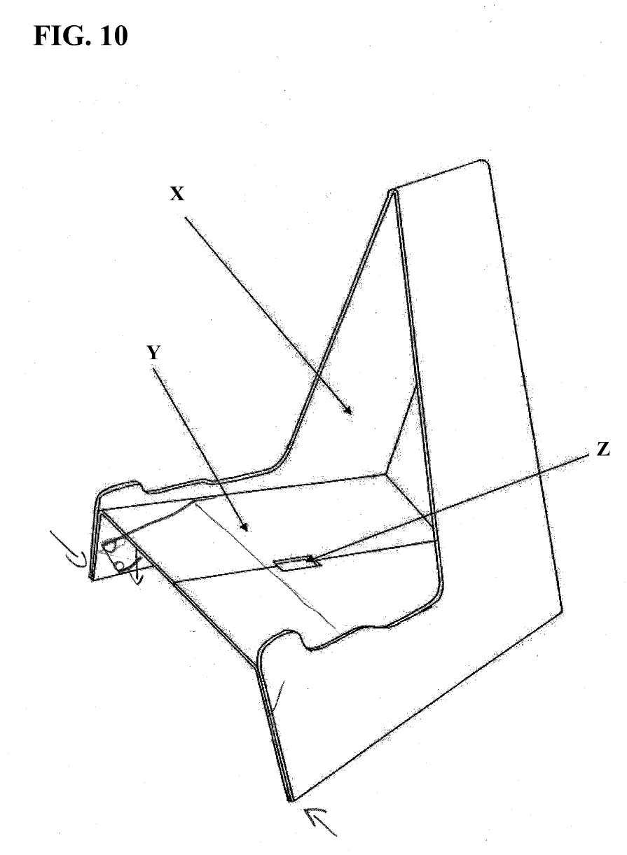

Said variant differs from the embodiment described previously in that the platform 3, the central line of folding of which is designated by 12, has at the front a reinforcing cross member 5 connected thereto via a line of folding 6 and formed, at its ends, with engagement tabs 7, designed to engage by being slotted into corresponding slits 8 formed through the feet 1a. The reinforcing cross member has a central folding line 14 that enables folding into the collapsed condition of the support represented in FIG. 9.

Of course, the details of construction and the embodiments may vary widely with respect to what is described and illustrated herein, without thereby departing from the scope of the present invention as defined in the ensuing claims.

1. A support for stringed musical instruments, comprising:
a resting base and a supporting upright for supporting the instrument formed by elements that are mobile between a condition of use and a collapsed condition for being carried, wherein said mobile elements are shaped as a plane plate.

2. The support according to claim 1, wherein said plane-plate elements are made of cardboard.

3. The support according to claim 1, wherein said plane-plate elements are made of a material chosen from a group consisting of PVC, slightly expanded closed-cell foamed PVC, polycarbonate, Plexiglas, wood and metal.

4. The support according to claim 2, wherein said plane-plate elements are made of a single dinked and creased sheet.

5. The support according to claim 4, wherein said supporting upright consists of a pair of side pieces articulated like a book at one end and formed at the other end with respective appendages defining two feet of the resting base, said feet having respective internal flaps folded and interconnected by a platform that can be folded between said uprights in said collapsed condition of the support to enable it to be carried.

6. The support according to claim 5, wherein said platform is connected to said folded flaps via respective lateral folding lines and has a central folding line.

7. The support according to claim 6, wherein said platform is formed, in an area corresponding to said central folding line, with a through opening.

8. The support according to claim 5, wherein said resting feet have respective top edges shaped to form first and second resting seats for the bodies of stringed instruments of smaller or greater thickness, and respective terminal stopper projections.

9. The support according to claim 5, wherein the edges of said side pieces facing said platform and the top edges of said resting feet are provided with an anti-slip strip.

10. The support according to claim 5, wherein said single dinked and creased sheet has a foldable joint in an area corresponding to said end of the side pieces articulated like a book.

11. The support according to claim 5, wherein said resting feet are moreover interconnected by a flexible stay.

12. The support according to claim 1, wherein said supporting upright consists of a pair of side pieces articulated like a book at one end and formed at the other end with respective appendages defining two feet of the resting base, said feet being interconnected by a foldable platform having one folded end defining a reinforcing cross member provided with an engagement end for anchorage to said feet.

13. The support according to claim 5, wherein said side pieces define respective extensive surfaces that can be used for application of advertising and promotional information.
